(19) United States
(12) Patent Application Publication
(10) Pub. No.: US 2013/0177480 A1
(43) Pub. Date: Jul. 11, 2013

(54) PHOTOLUMINESCENT ANALYTE PARTIAL VOLUME PROBE SET

(71) Applicants: Richard Fernandes, Clane (IE); Dmitri Boris Papkovsky, Blarney (IE)

(72) Inventors: Richard Fernandes, Clane (IE); Dmitri Boris Papkovsky, Blarney (IE)

(21) Appl. No.: 13/634,670

(22) PCT Filed: Mar. 16, 2010
(86) PCT No.: PCT/IE10/00013

§ 371 Date: Nov. 5, 2012

(51) Int. Cl. G01N 21/64

(52) U.S. Cl. CPC G01N 21/643
USPC 422/91

(57) ABSTRACT

A self-contained, remotely interrogatable, autonomously positionable, pressure probe (20) set from which the volume fraction of a gaseous target-analyte (V_{A}) in a mass, susceptible to changes in both total pressure of the mass (P_{T}) and concentration of target-analyte in the mass (V_{A}), can be ascertained, and methods of manufacturing and using. The probe set includes (i) a first probe (21) comprises an optically-active, target-analyte partial pressure sensitive material (31) configured and arranged to experience changes in P_{A} in the mass, whereby the first probe can report P_{A} in the mass, and (ii) a second probe (22) comprises an optically-active, P_{A}-sensitive material constrained to experience changes in P_{T} without experiencing changes in the V_{A}, whereby the second probe can report P_{T} of the mass.

### BACKGROUND

Solid-state polymeric materials based on oxygen-sensitive photoluminescent dyes are widely used as optical oxygen sensors and probes. See, for example United States Published Patent Applications 2009/0029402, 2008/8242870, 2008/215254, 2008/199360, 2008/190172, 2008/148817, 2008/146460, 2008/117418, 2008/0051646, and 2006/0002822, and U.S. Pat. Nos. 7,569,395, 7,534,615, 7,368,153, 7,138,270, 6,689,438, 5,718,842, 4,810,655, and 4,476,870. Such optical sensors are available from a number of suppliers, including Presens Precision Sensing, GmbH of Regensburg, Germany, Oxysense of Dallas, Tex., United States, and Luxcel Biosciences, Ltd of Cork, Ireland.

Such oxygen-sensitive photoluminescent dyes respond to the partial pressure of oxygen (P_{O2}), and are widely used in pressure-sensitive paints that can be applied to the surface of an object and interrogated to determine pressure distribution on the surface of the object exposed to a gas of known composition. See, for example United States Published Patent Applications 2007/112166, 2007/105235, 2006/101906, 2005/288475, 2004/0249593, 2004/091695, and 2003/175511, and U.S. Pat. Nos. 7,290,444, 7,176,272, 7,127,950, 5,965,642, 5,854,682, 5,818,057, 5,612,492, 5,359,887, 5,341,676, 5,307,675, and 5,186,046.

Manufacturers and suppliers of labile products, such as medical and biological products, pharmaceuticals and foodstuffs, typically package such products in a hermetically sealed package that has been flushed with an inert gas, such as nitrogen or a mixture of nitrogen and carbon dioxide, for purposes of reducing the concentration of oxygen within the package and thereby increasing the shelf-life of the product. It is known to employ oxygen sensitive optical probes within such packaging for providing a quick, easy, reliable and non-destructive means for measuring the concentration of oxygen within the packaging, from which the manufacturer can evaluate the integrity of the packaging process and/or the shelf-life status of packaged product in inventory. See, for example United States Published Patent Application 2009/0028756.

Such probes can accurately and reliably measure the content (volume fraction or percentage) of oxygen within packaging only when the total pressure within the packaging is known and remains substantially constant. However, in situations where a package is subject to appreciable fluctuations in total pressure within the package, such probes cannot consistently and reliably provide an accurate measurement of oxygen content as the probes are co-sensitive to changes in both oxygen content and total pressure.

Hence, a substantial need exists for a quick, easy, reliable and non-destructive means for consistently and reliably measuring oxygen content (volume fraction or percentage) within a hermetically sealed packaging susceptible to both changes in oxygen concentration and changes in total pressure.

### SUMMARY OF THE INVENTION

A first aspect of the invention is a probe set from which the volume fraction of a gaseous target-analyte (V_{A}) in a mass, susceptible to changes in both total pressure of the mass (P_{T}) and partial pressure of target-analyte in the mass (P_{A}), can be ascertained. The probe set includes a first probe and a second probe. The first probe comprises an optically-active, target-analyte partial pressure (P_{A}) sensitive material configured and arranged to experience changes in P_{A} in the mass, whereby the first probe can report P_{A} in the mass. The second probe comprises an optically-active, target-analyte partial pressure sensitive material constrained to experience changes in P_{T} without experiencing changes in the V_{A}, whereby the second probe can report P_{T} of the mass. Working together the probes form a probe set capable of providing an accurate determination of V_{A} in a mass.

The second probe is preferably a self-contained, remotely interrogatable, pressure probe including at least (i) a hermetically sealed, flexible, gas impermeable sachet capable of equilibriating to a surrounding pressure, (ii) an optically-active, target-analyte partial pressure sensitive material within the sachet, and (iii) a gaseous headspace within the sachet containing a known volume fraction of the target-analyte (V_{A}⁰). The sachet is preferably made of a material with a very low gas permeability, most preferably a material that is gas impermeable, so as to prevent any meaningful change in the composition, of the gas within the headspace of the sachet over the intended lifespan of the probe set.

A second aspect of the invention is an article of commerce comprising (i) a product retained within a hermetically sealed chamber of a package, and (ii) a probe set according to claim 1 within the chamber operable for sensing and reporting total pressure and target-analyte partial pressure within the chamber.

A third aspect of the invention is a method for determining the volume fraction of a target-analyte (V_{A}) within a hermetically sealed package employing a pressure probe set according to the first aspect of the invention. The method includes the steps of (A) obtaining an article of commerce according to the second aspect of the invention, (B) obtaining at least one analytical instrument capable of reading the optical activity of the first and second probes, (C) taking a reading from the first probe with an obtained analytical instrument, (D) correlating the value of the reading to a target-analyte partial pressure value (P_{A}) of the hermetically sealed chamber, (E) taking a reading from the second probe with an obtained analytical instrument, (F) con-elating the value of the reading to a total pressure value (P_{T}) of the hermetically sealed chamber, (G) calculating V_{A} within the chamber of the package from the values of P_{T} and P_{A}, and (H) reporting the calculated V_{A} within the chamber of the package.

The first and second probes are preferably constructed so that they may both be read with a single analytical instrument.

A fourth aspect of the invention is a method of manufacturing a probe set according to the first aspect of the invention. The method includes the steps of (A) preparing a composition of a target-analyte partial pressure sensitive photoluminescent dye in a suitable earner matrix, (B) applying the composition to a first support material, creating a first optically active target-analyte partial pressure sensitive sensor effective as the first partial pressure probe, (C) applying the composition to a second support material creating a second optically active target-analyte partial pressure sensitive sensor, and (D) hermetically sealing the second sensor and a gas having a known volume fraction of target-analyte (V_{A}⁰) within a flexible, gas impermeable sachet to form the second total pressure probe.

A preferred method of manufacturing the probe sets includes the steps of (1) hermetically packaging optically-active, target-analyte partial pressure sensitive material in a gaseous headspace having a known volume fraction of target-analyte (V_{A}⁰) within flexible, gas impermeable pockets on a blister pack, and (2) perforating the blister pack so as to expose selective pockets to the surrounding environment and form pairs of adjacent perforated and unperforated pockets on the blister pack, whereby the perforated pockets are first probes and the unperforated pockets are second probes.

The blister packs preferably have one column of perforated pockets, one column of unperforated pockets and a plurality of rows with a line of weakness between each row.

### BRIEF DESCRIPTION OF THE DRAWINGS

FIG. 1 is a top view of one embodiment of the probe set aspect of this invention provided as a continuous roll of probe sets.

FIG. 2 is a top view of a leading portion of the continuous roll of probe sets depicted in FIG. 1.

FIG. 3 is an enlarged cross-sectional end-view of the probe set depicted in FIG. 2 taken along line 3-3.

FIG. 4A is a grossly enlarged cross-sectional end view of the first probe depicted in FIG. 3.

FIG. 4B is a grossly enlarged cross-sectional end view of the second probe depicted in FIG. 3.

FIG. 5 is a side view of one embodiment of a hermetically sealed bottle containing a carbonated beverage and one of the probe sets depicted in FIGS. 1 and 2 with the probe set being interrogated by an analytical instrument.

FIG. 6 is top view of the bottle depicted in FIG. 5.

FIG. 7 is a side view of one embodiment of a hermetically sealed container containing a labile food product and one of the probe sets depicted in FIGS. 1 and 2.

### DETAILED DESCRIPTION OF A PREFERRED EMBODIMENT

### Definitions

As used herein, including the claims, the phrase “gas impermeable” means a gas transmission rate of less than 30 c³/m² day when measured in accordance with ASTM D1434.

As used herein, including the claims, the term “target-analyte” refers to a gaseous chemical substance, typically O₂, or CO₂, capable of modulating the optical signal emanating from an optically-active material such as a photoluminescent dye. The modulating effect may be achieved by quenching, (de)protonation or other means.

### Nomenclature

10 Probe Array
10_{Column 1} First Column of Probes in Probe Array
10_{Column 2} Second Column of Probes in Probe Array
10_{row} Row of Probes in Probe Array
19 Line of Weakness Between Rows
20 Probe Set
21 First Probe
21i First Probe Indicia
22 Second Probe
22i Second Probe Indicia
30 Solid State Composition
31 Target-Analyte-Sensitive Photoluminescent Dye
32 Target-Analyte-Permeable Polymer Matrix
40 Support Layer or Lidding
50 Formable Web
57 Pockets in Formable Web
58 Opening Into Second Probe Pockets
59 Cavity defined by Pockets
60 Pressure Sensitive Adhesive Layer
70 Release Liner
80 Outer Packaging for Roll of Probe Sets
100 Packaging or Container
101 Transparent or Translucent Cap or Covering on Package
108 Headspace within the Packaging
109 Retention Chamber of Packaging
200 Analytical Instrument
A Target-Analyte
P Product
P_{A} Partial Pressure of an Analyte
P_{T} Total Pressure of a Mass
V_{A} Volume Fraction of an Analyte in a Confined Space (e.g., the Retention Chamber of Packaging)
V_{A}⁰ Known Volume Fraction of an Analyte in a Confined Space (e.g., the Headspace of the Cavity defined by the Pockets)

### Description

Theory

The present invention utilizes the sensitivity of photoluminescent dyes to the partial pressure of an analyte (P_{A}) and Dalton's Law of Partial Pressure to provide a probe set capable of noninvasively measuring the partial pressure of an analyte (P_{A}) and the total pressure (P_{T}) of a sample susceptible to changes in both total pressure and concentration of analyte, from which the partial volume of the analyte (V_{A}) and thereby the concentration of the analyte (%_{A}) in the sample can be calculated.

Measuring Partial Pressure of an Analyte (P_{A})

The methods and compositions described herein are based on the quenching of photoluminescence by an analyte, typically oxygen (O₂). Luminescence encompasses both fluorescence and phosphorescence. Electromagnetic radiation in the ultraviolet or visible region is used to excite molecules to higher electronic energy levels. The excited molecules lose their excess energy by one of several methods. One of those methods is fluorescence. Fluorescence refers to the radiative transition of electrons from the first excited singlet state to the singlet ground state (S₁ to S₀). The lifetime of fluorescence is relatively short, approximately 10⁻⁹ to 10⁻⁷ seconds. However, intersystem crossing from the lowest excited singlet state to the triplet state often occurs and is attributed to the crossing of the potential energy curves of the two states. The triplet state so produced may return to the ground state by a radiative process known as phosphorescence. Phosphorescence is the radiative relaxation of an electron from the lowest excited triplet state to the singlet ground state (T₁ to S₀). Because the transition that leads to phosphorescence involves a change in spin multiplicity, it has a low probability and hence a relatively long lifetime of 10⁻⁴ to 10 seconds. Fluorescent and phosphorescent lifetime is known to change in a defined fashion relative to changes in P_{A} capable of quenching the photoluminescent molecules. Hence, the P_{A} in fluid communication with a photoluminescent material can be determined by measuring photoluminescence lifetime.

Measuring Total Pressure (P_{T})

Dalton's Law of Partial Pressure establishes that the total pressure (P_{T}) of an ideal gaseous mixture is equal to the sum of the partial pressures of the individual constituent gases (Pₙ). This law is represented mathematically for a two constituent mixture as:

P_{T}=P_{A}+P_{B}

A corollary to Dalton's Law of Partial Pressure establishes that a percentage change in the total pressure of a compositionally static gaseous mixture results in an identical percentage change in the partial pressure of each constituent gas. This corollary law is represented mathematically for a two constituent mixture as:

(ΔP_{T})/(P_{T Start})=(ΔP_{A})/(P_{A Start})=(ΔP_{B})/(P_{B Start})

Wherein ΔP=P_{New}−P_{Start}

Application of these laws permits the total pressure (P_{T}) of a compositionally static gaseous mixture to be calculated from a determination of the partial pressure of a given constituent of that gaseous mixture (P_{A}) so long as at least one pair of correlated values for total pressure (P_{T}) and partial pressure (P_{A}) of that constituent gas are known. For example, a gaseous mixture of 79% N₂ and 21% O₂ (i.e., air) at a total pressure (P_{Air}) of 1 atmosphere (101.325 kPa) is known to have a nitrogen partial pressure P_{N2} of 0.79 atmospheres (80.047 kPa) and an oxygen partial pressure P_{O2} of 0.21 atmospheres (21.278 kPa). If a subsequent analysis of this gaseous mixture indicates that the P_{O2} has increased from 21.278 kPa to 30.000 kPa, the total pressure of the air (P_{Air}), assuming no change in the composition of the air, can be calculated as follows:

ΔP_{O2}=30.000 kPa−21.278 kPa=8.722 kPa

(ΔP_{O2})/(P_{O2 Start})=8.722 kPa/21.278 kPa=0.410

(ΔP_{T})/(P_{T Start})=0.410

(P_{T New}−P_{T Start})/(P_{T Start})=0.410

(P_{T New}−101.325 kPa)/(101.325 kPa)=0.410

P_{T New}=142.868 kPa

Hence, total pressure (P_{T}) can be determined by measuring the photoluminescence lifetime of a target-analyte sensitive photoluminescent material exposed to a gaseous mixture that is capable of dynamically equilibrating to the surrounding pressure but has a known and static concentration of the target-analyte (P_{A}).

Calculating Volume Fraction of an Analyte (V_{A})

The volume fraction of an analyte (V_{A}) in a sample, and thereby the concentration of the analyte (%_{A}) in a sample, can be calculated from the analyte partial pressure (P_{A}) in the sample and the total pressure (P_{T}) of the sample using the following equations:

V_{A}=(P_{A}/P_{T})

%_{A}=(V_{A})(100)

Hence, V_{A}, and thereby %_{A}, in a sample can be accurately ascertained by measuring P_{A} in the sample and P_{T} of the sample.

Applicant has discovered an inexpensive, self-contained, remotely interrogatable and autonomously positionable probe set 20 capable of quickly, easily and reliably ascertaining and reporting both P_{A} and P_{T} of a sample susceptible to both changes in oxygen concentration and changes in total pressure, such as the headspace 108 of a filled beverage bottle 100 or the headspace 108 of a filled retort package 100, in a non-invasive and non-destructive manner.

Construction

A first aspect of the invention is a probe set 20 from which the volume fraction of a gaseous target-analyte A in a mass (V_{A}), susceptible to changes in both total pressure of the mass (P_{T}) and partial pressure of target-analyte A in the mass (P_{A}), can be ascertained. The probe set 20 includes a first probe 21 capable of detecting P_{A} and a second probe 22 capable of detecting P_{T}. The first probe 21 comprises an optically-active, target-analyte partial pressure sensitive material 30 configured and arranged to experience changes in target-analyte partial pressure P_{A} in the mass, whereby the first probe 21 can report P_{A} in the mass. The second probe 22 comprises an optically-active, target-analyte partial pressure sensitive material 30 constrained to experience changes in P_{T} of the mass without experiencing changes in the V_{A} in the mass, whereby the second probe 22 can report P_{T} of the mass.

For purposes of simplicity only, and without intending to be limited thereto, the balance of the description may reference O₂ as the target-analyte A since O₂-sensitive probes are the most commonly used types of optically active probes.

First Analyte Partial Pressure Probe 21

Referring generally to FIGS. 2,3 and 4A, the first probe 21 is an oxygen partial pressure sensitive probe 21 useful for optically ascertaining the partial pressure of oxygen (P_{O2}) within an enclosed space, such as the retention chamber of a hermetically sealed package 100. The first probe 21 includes a thin film of a solid state photoluminescent composition 30 coated onto a support layer 40. The solid state photoluminescent composition 30 includes an oxygen partial pressure sensitive (P_{O2} sensitive) photoluminescent dye 31 embedded within an oxygen permeable polymer matrix 32.

The oxygen-sensitive photoluminescent dye 31 used in the solid state photoluminescent composition 30 of the first probe 21 may be selected from any of the well-known P_{O2} sensitive photoluminescent dyes 31. One of routine skill in the art is capable of selecting a suitable dye 31 based upon the intended use of the probe set 20. A nonexhaustive list of suitable oxygen sensitive photoluminescent dyes 21 includes specifically, but not exclusively, ruthenium(II)-bipyridyl and ruthenium(II)-diphenylphenanothroline complexes, porphyrin-ketones such as platinum(II)-octaethylporphine-ketone, platinum(II)-porphyrm such as platinum(II)-tetrakis(pentafluorophenyl)porphine, palladium(II)-porphyrin such as palladium(II)-tetrakis(pentafluorophenyl)porphine, phosphorescent metallocomplexes of tetrabenzoporphyrins, chlorins, azaporphyrins, and long-decay luminescent complexes of iridium(III) or osmium(II).

Typically, the oxygen-sensitive photoluminescent dye 31 is compounded with a suitable oxygen-permeable hydrophobic carrier matrix 32. Again, one of routine skill in the art is capable of selecting a suitable oxygen-permeable hydrophobic carrier matrix 32 based upon the intended use of the probe set 20 and the selected dye 31. A nonexhaustive list of suitable polymers for use as an oxygen-permeable hydrophobic carrier matrix 32 includes specifically, but not exclusively, polystyrene, polycarbonate, polysulfone, polyvinyl chloride and some co-polymers. The photoluminescent composition 30 may be provided as a dispersed material, for example as aqueous suspension or powder of polymeric microparticles or nanoparticles impregnated with an oxygen-sensitive photoluminescent dye 31.

The support layer 40 may be selected from any of the materials commonly employed as a support layer for a P_{O2} sensitive photoluminescent solid state composition 30. One of routine skill in the art is capable of selecting the material based upon the specific analyte to be detected and the intended use of the probe set 20. A nonexhaustive list of substrates includes specifically, but not exclusively, cardboard, paperboard, polyester Mylar® film, non-woven spinlaid fibrous polyolefin fabrics, such as a spunbond polypropylene fabric.

The support layer 40 is preferably between about 30 μm and 500 μm thick.

Second Total Pressure Probe 22

Referring generally to FIGS. 2, 3 and 4B, the second probe 22 is configured and arranged for optically ascertaining the total pressure within an enclosed space, such as the retention chamber of a hermetically sealed package 100. The second probe 22 is comprised of a hermetically sealed, flexible, gas impermeable pocket or sachet 57 with a thin film of a solid state photoluminescent composition 30 sensitive to the partial pressure of a target-analyte A (e.g., P_{O2}) and a gaseous headspace containing a known concentration of the target-analyte A (e.g., V_{O2}⁰ or P_{O2}⁰) retained within the cavity 59 defined by the pocket 57.

The cavity 59 is hermetically sealed and the pocket or sachet 57 constructed from a gas impermeable material for purposes of ensuring that the composition of the gas within cavity 59 does not appreciably change during the intended lifespan of the probe set 20. A change in the composition of the gas within the cavity 59 can introduce significant error as both the sensor readings and the subsequent calculations utilizing those sensor readings are based upon the assumption that any change in target-analyte partial pressure results exclusively from a change in pressure, not a change in the concentration of target-analyte A. The pocket or sachet 57 is also sufficiently flexible to ensure that the pressure within the cavity 59 dynamically equilibrates to the surrounding pressure, thereby allowing the pressure of the gas within the cavity 59 ascertained by interrogating the second probe 22 to be equated to the pressure surrounding the probe 22. Those of routine skill in the art are capable of selecting suitable materials for use in constructing the pocket or sachet 57. A nonexhaustive list of suitable materials from which the pocket or sachet 57 may be constructed includes specifically, but not exclusively, polymeric films made of polyester (e.g., Mylar®), polyvinylidene chloride (PVDC), polyethylene vinyl alcohol (EVOH) and laminates based on these polymers, and other films which possess or have been coated to provide very low gas permeability characteristics.

The gaseous headspace within the pocket or sachet 57 contains a known concentration of a target-analyte A. The amount of target-analyte A within the headspace need not be strictly controlled, but must be known, needs to remain substantially constant throughout the lifespan of the probe set 20, and should fall within a concentration that provides good sensitivity over the anticipated changes in target-analyte partial pressure. For example, when the target-analyte A is oxygen (O₂) it is convenient to simply fill the cavity 59 with air which contains 20.9% O₂ by volume. However, the sensitivity of the second probe 22 within higher pressure ranges can be enhanced by limiting the O₂ concentration within the headspace of the cavity 59 to a concentration of between 0.1 to 20% by volume O₂, preferably 2 to 10% by volume O₂, and most preferably between 3 to 6% by volume O₂. Concentrations below 0.1% tend to lose sensitivity due to an overly diminished quenching of the photoluminescent dye 31 while concentrations above 20.9% tend to lose sensitivity as changes in quenching of the photoluminescent dye 31 resulting from changes in P_{O2} are overwhelmed by the total quenching effect of the O₂ to which the photoluminescent dye 31 is exposed.

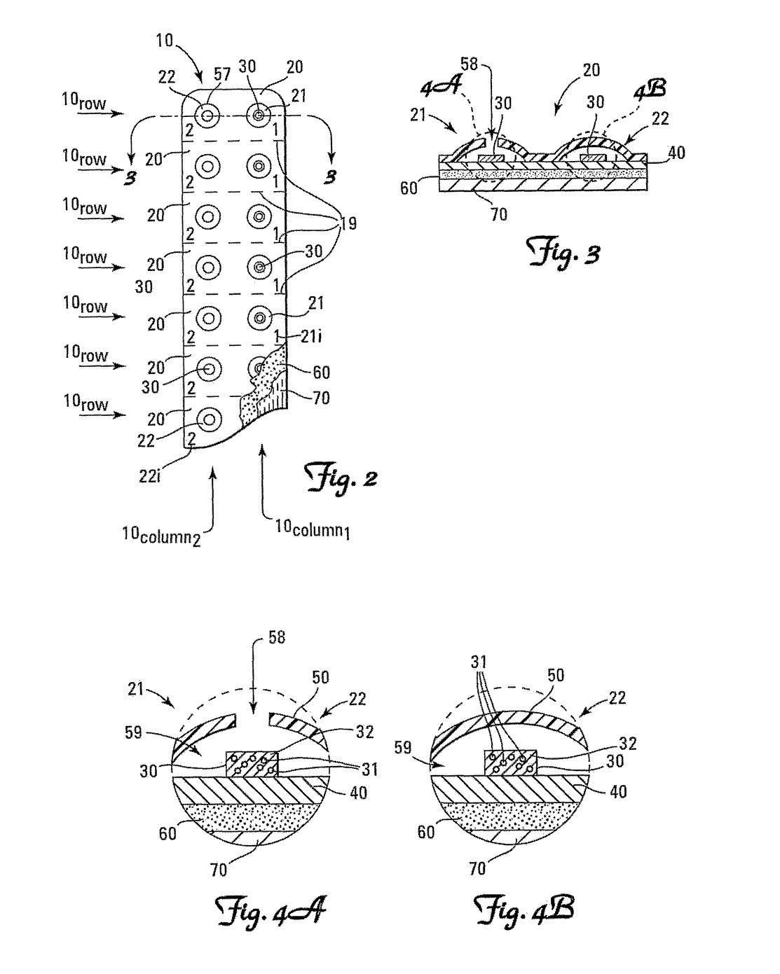

The solid state photoluminescent composition 30 may either be coated onto a support or lidding layer 40 as depicted in FIGS. 2 and 4B, or coated directly onto the interior surface of pockets 57 formed in a formable web 50.

As with the first probe 21, the solid state photoluminescent composition 30 includes an oxygen partial pressure sensitive (P_{O2} sensitive) photoluminescent dye 31 embedded within an oxygen-permeable polymer matrix 32. It is generally preferred to use the same solid state photoluminescent composition 30 in both the first 21 and second 22 probes, thereby permitting the first 21 and second 22 probes to be interrogated by the same optical detection mechanism such that a single optical detector 200 can be employed to read both probes 21 and 22.

The support layer 40 may be selected from any of the materials commonly employed as a support layer for a P_{O2} sensitive photoluminescent solid state composition 30. One of routine skill in the art is capable of selecting the material based upon the intended use of the probe set 20. A nonexhaustive list of substrates includes specifically, but not exclusively, cardboard, paperboard, polyester Mylar® film, non-woven spinlaid fibrous polyolefin fabrics, such as a spunbond polypropylene fabric. When the support layer 40 is also employed to hermetically seal the pocket or sachet 57 and prevent changes in oxygen concentration within the cavity 59 (i.e., when the support layer 40 also functions as a blister pack lidding layer 40), the material used as the support layer 40 needs to be gas impermeable in addition to possessing those properties and characteristics necessary to function as a support layer 40. One such example is Mylar® film.

The support layer 40 is preferably between about 30 μm and 500 μm thick.

It is noted that the concentration of oxygen in the surrounding environment (e.g., the headspace 108 of a hermetically sealed container 100) does not impact readings taken from the second probe 22 as the photoluminescent solid state composition 30 on the second probe 22 is never exposed to the gaseous content of the surrounding environment. Hence, the second probe 22 is capable of providing accurate measurements of total pressure regardless of the complete absence or change in concentration of oxygen in the surrounding environment (e.g., within the headspace 108 of a hermetically sealed container 100).

Probe Set 20

Referring to FIGS. 2 and 3, the probe set 20 preferably includes an adhesive layer (preferably a pressure sensitive adhesive) 50 for facilitating attachment of the probe set 20 to a surface of a container 100 that defines an enclosed space 109 whose analyte volume fraction (V_{A}) (e.g., Y_{O2}) is to be measured, with the photoluminescent solid state composition 30 on each probe 21 and 22 facing outward from the container 100 through an area of the container 100 that is transparent or translucent to radiation at the excitation and emission wavelengths of the dye 31 in the photoluminescent solid state compositions 30 forming the first 21 and second 22 probes. The adhesive 60 may, but should not cover the photoluminescent solid state compositions 30.

The materials of construction can be selected to provide the probe set 20 with an appropriate balancing of cost and useful lifespan. Generally, the probe set 20 should be constructed to ensure a useful lifespan of at least two to three months, preferably six to twelve months, for purposes of allowing the probe set 20 to be retained in inventory for several months prior to use and providing a probe set 20 that can remain effective from a few weeks to a few months after it has been deployed in a hermetically sealed package or container 100.

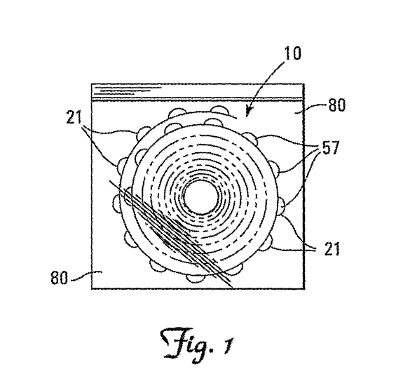

Referring to FIG. 1, the useful lifespan of probe sets 20, more precisely the lifespan of the second probes 22, can be increased by hermetically sealing the probe sets 20 within a gas impermeable outer package 80 along with a gaseous headspace (unnumbered) having a volume fraction of oxygen (V_{O2}) substantially the same as that within the cavity 59 of the second probes 22 (i.e., within 10%, preferably within 2% and most preferably within 0.5%).

Referring to FIGS. 1, 2 and 3, probe sets 20 can be conveniently produced by employing blister pack packaging technology to package a mass of a photoluminescent solid state composition 30 within hermetically sealed, flexible, gas impermeable pockets 57 to form an array of probes 10 all functional as a second probe 22. Selected pockets 57 can then be perforated so as to place in the photoluminescent solid state composition 30 within the pocket 57 into fluid communication with the surrounding environment, thereby converting such pockets 57 from a second probe 22 to a first probe 21. The photoluminescent solid state composition 30 can be coated onto either the lidding 40 or the formable web 50 forming each pocket 57.

Probe sets 20 can be provided in an easily accessible and dispersible format by providing an array 10 of pockets 57 having two columns, with the pockets 57 in one column 10_{Column 1} formed into first probes 21 by perforating the pockets 57, and the pockets 57 in the other column 10_{Column 2} formed into second probes 22 whereby each row 10_{Row} forms a probe set 20. A line of weakness 19, such as a line of perforations, can be provided between each row 10_{Row} so that individual probe sets 20 can be quickly and easily separated from the blister pack by machine or hand. Referring to FIG. 1, the blister pack is preferably sufficiently supple to be rolled onto a core (unnumbered) for facilitating packaging, storage, shipping and handling.

Article of Commerce Equipped with a Probe Set 20

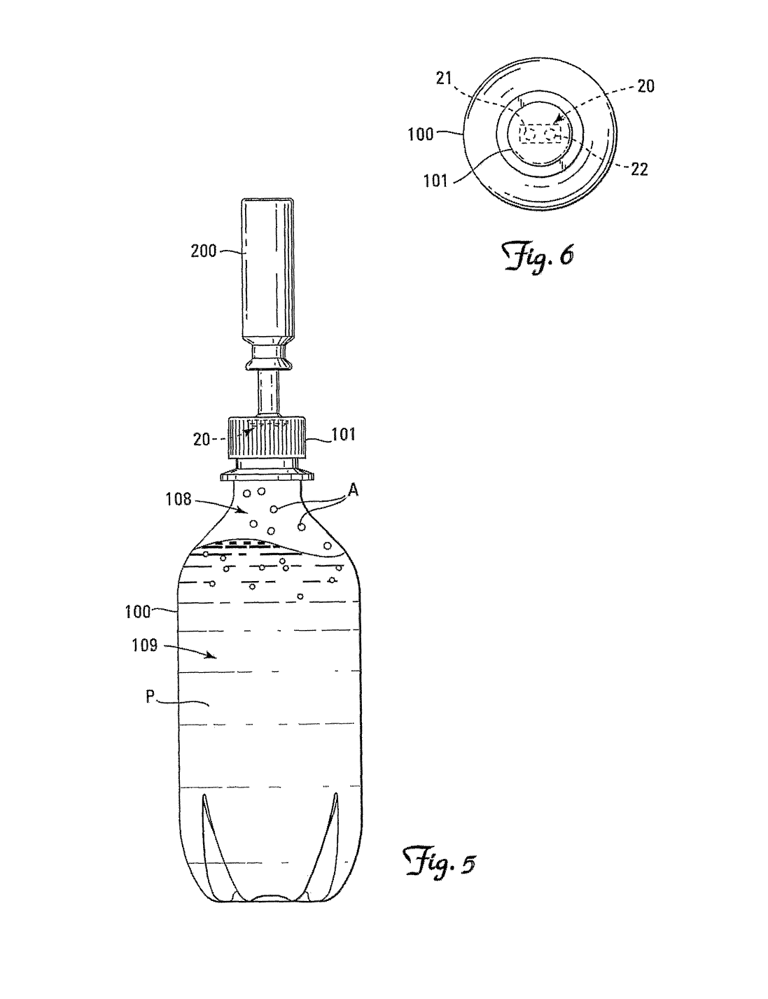

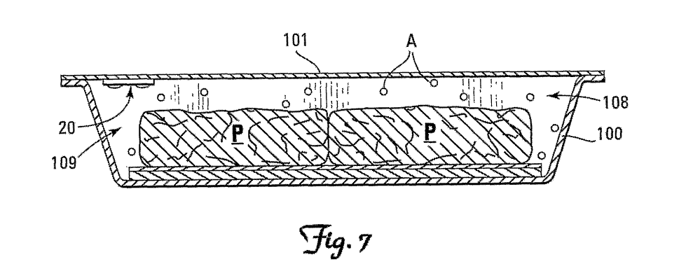

Referring generally to FIGS. 5, 6 and 7, a second aspect of the invention is an article of commerce comprising a product P, typically a labile product P, packaged within a hermetically sealed container 100 with a probe set 20 positioned within the headspace 108 of the container 100.

The probe set 20 should be positioned within the headspace 108 of the container 100 so that the probe set 20 can be easily located and the P_{O2} sensitive photoluminescent solid state composition 30 of both probes 21 and 22 presented for interrogation by an analytical reader (i.e. a light detector) 200 through the packaging 100 and through the various layers of material used to form the probe set 20. Hence, at least that portion of the packaging 100 overlaying the probe set 20 needs to be transparent or translucent to radiation at the excitation and emission wavelengths of the dye 31 in the photoluminescent solid state composition 30 of both probes 21 and 22 in the probe set 20 so that the probes 21 and 22 may be interrogated by an analytical reader 200 in a noninvasive and nondestructive manner.

The ability to quickly and inexpensively monitor an analyte partial volume (V_{A}), such as V_{O2}, within a sealed container 100 in a nondestructive and noninvasive manner is particularly valuable when the product P within the container 100 is a labile product P that is subject to (i) target-analyte generative deterioration or spoilage, as is true for a wide variety of foodstuffs such as processed cereals, snack foods, prepared meals and meats, (ii) target-analyte consuming deterioration or spoilage, as is true for a respiring product P, (iii) deterioration due to a loss of pressure, such as that observed with carbonated beverages, (iv) deterioration due to loss of a specific target-analyte A within the headspace 108 of the container 100, (v) subject to deterioration or spoilage in the absence of an expected increase or decrease in the concentration of a specific analyte A within the container 100 after the container 100 has been hermetically sealed.

It is also valuable in situations where the product P has been packaged under vacuum and a premature loss of vacuum can significantly affect the shelf-life of the product P, such as tuna vacuum packed in a gusseted pouch.

Still further, it is valuable in situations where pressure within the packaging is expected to increase or decrease shortly after the product P has been packaged within the container 100, such as is observed when foodstuffs are sealed within the packaging 100 while still hot, and thereafter cooled to room temperature or below.

Manufacture

The P_{A}-sensitive (typically P_{O2}-sensitive) solid state composition component 30 of the first 21 and second 22 probes can be manufactured by the traditional methods employed for manufacturing such probes 21 and 22. Briefly, the component 30 can be conveniently manufactured by (A) preparing a coating composition (not shown) which contains the photoluminescent P_{A}-sensitive dye 31 and the analyte-permeable polymer 32 in an organic solvent (not shown) such as ethylacetate, (B) applying the coating composition to a surface of a support material 40 or soaking the support material 40 in the coating composition (not shown), and (C) allowing the coating composition (not shown) to dry, whereby a solid-state thin film coating 30 is formed on the support 30. The resultant P_{A}-sensitive solid state composition component 30 is preferably heat treated to remove mechanical stress from the sensor material which is associated with its preparation (solidification and substantial volume reduction).

Generally, the concentration of the polymer 32 in the organic solvent (not shown) should be in the range of 0.1 to 20% w/w, with the ratio of dye 31 to polymer 32 in the range of 1:50 to 1:5,000 w/w.

A layer of pressure sensitive adhesive 60 can optionally be coated onto a major surface of the support material 40 by conventional coating techniques, and optionally covered with a release liner 70.

The first probe 21 requires no further processing or assembly. The second probe 22 requires placement of the P_{A}-sensitive solid state composition component 30 within a hermetically sealed, flexible, gas impermeable pocket or sachet 57 having a gaseous headspace 59 containing a known volume fraction of the target-analyte (V_{A}) and capable of equilibriating to a surrounding pressure. For example, the second probe 22 can be formed by placing the P_{A}-sensitive solid state composition component 30 between upper and lower layers of a flexible, gas impermeable film, such as Mylar, and forming a hermetically sealed sachet 57 from the upper and lower layers of film that encloses component 30 along with a supply of a gas, such as air, having a known concentration of the target-analyte.

As referenced previously, one of routine skill in the art would also be able to produce a supply of probe sets 20 each having a first probe 21 and a second probe 22 by incorporating P_{A}-sensitive solid state composition component 30 within each “pocket” in a blister pack array or each “bubble” in a sheet of bubble wrap with perforation of alternating pockets or bubbles.

Use

The probe set 20 can be used to quickly, easily, accurately and reliably measure the target-analyte A partial volume (V_{A}) within a hermetically sealed package 100. The probe set 20 can be interrogated and used to measure V_{A} in essentially the same manner as a typical oxygen sensitive photoluminescent probe is interrogated and used to measure the concentration of a target-analyte A within an enclosed space. Briefly, the probe set 20 is used to measure V_{A} within the retention chamber 109 of a hermetically sealed package 100 by (A) placing the probe set 20 within the retention chamber 109 at a location that is in fluid communication with the gaseous headspace 108 in the retention chamber 109 and where radiation at the excitation and emission wavelengths of the dye 31 can be transmitted to and received from the photoluminescent solid state compositions 30 with minimal interference and without opening or otherwise breaching the integrity of the package 100, such as a transparent or translucent cap 101 on a bottle 100 or lidding 101 on a container 100, (B) allowing the pressure within the second probe 22 to equilibrate to the pressure within retention chamber 109 of the package 100—typically less than several seconds, (C) ascertaining partial pressure of the target-analyte A (P_{A}) within the retention chamber 109 by (i) repeatedly exposing the first probe 21 to excitation radiation over time, (ii) measuring radiation emitted by the excited first probe 21 after at least some of the exposures, (iii) measuring passage of time during the repeated excitation exposures and emission measurements, and (iv) converting at least some of the measured emissions to a target-analyte A partial pressure P_{A} based upon a known conversion algorithm or look-up table, (D) ascertaining the total pressure within the retention chamber 109 by (i) repeatedly exposing the second probe 22 to excitation radiation over time, (ii) measuring radiation emitted by the excited second probe 22 after at least some of the exposures, (iii) measuring passage of time during the repeated excitation exposures and emission measurements, (iv) converting at least some of the measured emissions to P_{A} within the pocket or sachet 57 based upon a known conversion algorithm or look-up table, (v) calculating the total pressure within the pocket or sachet 57 from the determined P_{A} and known V_{A}⁰ within the pocket or sachet 57 by applying Dalton's Law of Partial Pressure and its corollary and at least one known pair of correlated values for total pressure (P_{T}) and P_{A}, and (vi) equating the calculated P_{T} within the sachet 57 to P_{T} within the retention chamber 109 of the packaging 100, and (E) calculating V_{A} within the retention chamber 109 from the values of P_{T} and P_{A}. The conversion algorithms employed in this process are well know to and readily developable by those with routine skill in the art.

Interrogation of the probe set 20 can be accomplished in a non-destructive fashion with an external optical detector 200.

The probes 21 and 22 may be sensitive to temperature. In order to ensure accurate measurements, readings obtained from the probes 21 and 22 may need to be adjusted to compensate for any temperature induced variation. These relationships are well known and widely published for a wide variety of target-analyte sensitive photoluminescent solid state compositions 30.

For particular applications, the probe set 20 may be used to signal “expiration” of a packaged labile product P by programming the analytical instrument 200 used to interrogate a probe set 20 within a package 100 to compare the P_{A}, P_{T} and/or V_{A} values obtained by interrogating a probe set 20 within the packaging 100 to a predetermined threshold value indicative of product P expiration, and generate a signal when the value falls beyond that threshold value, indicating that the product P should not be sold for human consumption.

The radiation emitted by each of the excited probes 21 and 22 can be measured in terms of intensity and/or lifetime (rate of decay, phase shift or anisotropy), with measurement of lifetime generally preferred as a more accurate and reliable measurement technique, especially when seeking to establish P_{O2} via measurement of the extent to which the dye 31 has been quenched by oxygen.

### EXAMPLES

### Example 1

### (Manufacture of First P_{O2} Probe—Polypropylene Support Layer)

One milligram of the phosphorescent oxygen-sensitive dye PtOEPK (platinum(II) octaethylporphyrinketone) was dissolved in 4 ml of 2.5% solution of polystyrene (M.W. 280,000) in ethylacetate to form a coating composition. This composition was applied with a micropipette in 5 μL aliquots on a 155 μm thick micro porous polypropylene membrane and allowed to dry, forming an array of solid-state P_{O2} probes. Individual probes were produced by cutting the membrane into dots having a diameter of approximately 10 mm.

The P_{O2} probes were batch-calibrated using a set of standards (0-100% O₂ gas balanced with N₂) and a Luxcel fibre-optic detector to obtain phosphorescence phase shift readings. These readings were performed at ambient pressure and 25° C.

### Example 2

### (Manufacture of First P_{O2} Probe—PET/PVDC/PP Support Layer)

One milligram of the phosphorescent oxygen-sensitive dye PtOEPK (platinum(II) octaethylporphyrinketone) was dissolved in 4 ml of 2.5% solution of polystyrene (M.W. 280,000) in ethylacetate to form a coating composition. This composition was applied with a micropipette in 5 μL aliquots onto a film laminate of PET/PVDC/PP and allowed to dry, forming an array of solid-state P_{O2} probes.

The P_{O2} probes were batch-calibrated using a set of standards (0-100% O₂ gas balanced with N₂) and a Luxcel fibre-optic detector to obtain phosphorescence phase shift readings. These readings were performed at ambient pressure and 25° C.

### Example 3

### (Manufacture of Second P_{T} Probe)

Sachets were formed from a film laminate of PET/PVDC/PP. Each sachet was formed by overlapping two 8×8 cm pieces of the film and heat-sealing the layers together along three sides with a double seal employing an industrial heat-sealing machine—forming a pouch with an open end. One of the P_{O2} probes formed in Example 1 was inserted inside the pouch through the open end and positioned within the pouch so that the P_{O2} probe faced the wide side and could be interrogated from outside the pouch. A styrofoam insert was placed within the pouch through the open end to ensure that the pouch retained a volume of air when sealed. The open end of the pouch was then sealed under ambient air pressure and excess film removed with a pair of scissors to form P_{T} probes, each comprising a hermetically sealed sachet encasing a P_{O2} probe and a supply of air within an approximately 3×3 cm cavity.

### Example 4

(Manufacture of Second P_{T} Probe Filled with Reduced Oxygen)

Probes were formed in accordance with Example 3 except that the pouches were flushed with a gas containing approximately 5% oxygen just prior to sealing the open end of the pouch. Performance of one of these probes was monitored, at ambient temperature and pressure in room air, using a phosphorescent phase detector over a 24 hour period. During this period no significant changes in sensor phase signal were observed, indicating that the sachet material and fabrication technology provides an effective gas-barrier.

### Example 5

(Manufacture of Second P_{T} Probe Filled with Air)

One milligram of the phosphorescent oxygen-sensitive dye PtOEPK (platinum(II) octaemylporphyrinketone) was dissolved in 4 ml of 2.5% solution of polystyrene (M.W. 280,000) in ethylacetate to form a coating composition. This composition was applied with a micropipette in 5 μL aliquots onto a film laminate of PET/PVDC/PP and allowed to dry, forming an array of solid-state P_{O2} probes.

The P_{O2} probes were batch-calibrated using a set of standards (0-100% O₂ gas balanced with N₂) and a Luxcel fibre-optic detector to obtain phosphorescence phase shift readings. These readings were performed at ambient pressure and 25° C.

Sachets were formed from the film laminate of PET/PVDC/PP upon which the P_{O2} probes were formed, each containing a single P_{O2} probe on the inside surf ace of the sachet. Square 8×8 cm pieces of the film were cut out and folded so as to position the P_{O2} probe between the folded layers of film. A styrofoam insert was placed between the folded layers of film to ensure that the sachet retained a volume of air when sealed, and the folded layers heat-sealed tightly with a double seal along all three sides. Excess film was removed with a pair of scissors to form P_{T} probes, each comprising a hermetically sealed sachet encasing a P_{O2} probe and a supply of air within an approximately 3×3 cm cavity.

### Example 6

### (Use of Air Filled P_{T} Probe to Measure Air Induced Pressure Changes)

One of the pressure probes manufactured in Example 3 was inserted into and attached to the inner wall of a 100 ml bottle. A Luxcel fiber-optic phosphorescence phase detector was positioned to interrogate the probe through the wall of the bottle.

The bottle was sealed with an air-tight cap having an inlet and an outlet flow channel therethrough. The inlet flow channel was connected to a cylinder of compressed air. The outlet channel was closed and the internal pressure inside the bottle increased gradually by means of a pressure regulator on the cylinder of compressed air. Phase/lifetime signals were obtained from the probe by the detector at ambient pressure and at stepwise increases in pressure of 1.0 and 2.0 Bar above ambient pressure. Results are reported in Table One below. As shown in Table One, a stepwise change in phase signal was observed at each stepwise change in pressure. Such changes were in agreement with the P_{O2} calibration of the probe.

TABLE ONE

| | PHASE SIGNAL |
|---|---|
| PRESSURE INSIDE BOTTLE | (DEGREES) |
| Ambient | 11.1 |
| Ambient + 1.0 Bar | 7.2 |
| Ambient + 2.0 Bar | 3.7 |

Upon the release of pressure within the bottle, the phase/lifetime signal obtained from the probe quickly returned to its original value, indicating that the probe responds quickly and reversibly to changes in external pressure with a corresponding change in phosphorescence intensity and decay characteristics.

The probe was then exposed to a reduced pressure of 0.8 Bar with a concomitant increase in sensor signal (phase shift).

### Example 7

### (Use of Air Filled P_{T} Probe to Measure Carbon Dioxide Induced Pressure Changes)

Example 6 was duplicated, except that the inlet flow channel was connected to a cylinder of compressed carbon dioxide. The probe produced practically the same changes in its phosphorescent signal as when air was used to change the pressure within the bottle. This illustrates that the probes response to changes in surrounding pressure is consistent and independent from the composition of the external gas applying pressure upon the probe.

### Example 8

### (Use of Reduced Oxygen P_{T} Probe to Measure Air Induced Pressure Changes)

Example 6 was duplicated, except that a pressure probe of Example 4 was employed. Phase/lifetime signals were obtained from the probe by the detector at ambient pressure and at stepwise increases in pressure of 0.5, 1.0, 1.5 and 2.0 Bar above ambient pressure. Results are reported in Table Two below. As shown in Table Two, a stepwise change in phase signal was observed at each stepwise change in pressure. Such changes were in agreement with the P_{O2} calibration of the probe. The probe produced a distinct and reversible response to changes in external pressure, but with a larger signal change in response to smaller changes in external pressure from ambient pressure relative to the pressure probe of Example 3.

TABLE TWO

| | PHASE SIGNAL |
|---|---|
| PRESSURE INSIDE BOTTLE | (DEGREES) |
| Ambient | 21.44 |
| Ambient + 0.5 Bar | 18.77 |
| Ambient + 1.0 Bar | 16.29 |
| Ambient + 1.5 Bar | 13.61 |
| Ambient + 2.0 Bar | 11.17 |

### Example 9

### (Use of Air Pressure P_{T} Probe to Measure Air Induced Pressure Changes)

Example 6 was duplicated, except that a pressure probe of Example 5 was employed. The probe produced a distinct and reversible response to changes in external pressure consistent with the responses observed in Examples 6 and 7.

1. A probe set from which the volume fraction of a gaseous target-analyte in a mass can be ascertained, comprising:
(a) a first probe comprising an optically-active, target-analyte partial pressure sensitive material constrained to experience changes in the total pressure of the mass without experiencing changes in the volume fraction of target-analyte in the mass, whereby the first probe can report total pressure of the mass, and
(b) a second probe comprising an optically-active, target-analyte partial pressure sensitive material configured and arranged to experience changes in target-analyte partial pressure in the mass, whereby the second probe can report target-analyte partial pressure in the mass.

2. The probe set of claim 1 wherein the first and second probes are united to form a unitary probe set.

3. The probe set of claim 2 wherein the probe set is autonomously positionable.

4. The probe set of claim 1 wherein (i) the optically active material on the first and second probes is sensitive to the partial pressure of oxygen, and (ii) the first and second probes are identifiable as a first probe or a second probe.

5. The probe set of claim 1 wherein the mass is retained within a hermetically sealed chamber of a container.

6. The probe set of claim 1 wherein the first probe is a self-contained, remotely interrogatable, pressure probe including at least (i) a hermetically sealed, flexible, gas impermeable sachet capable of equilibrating to a surrounding pressure, (ii) an optically-active, target-analyte partial pressure sensitive material within the sachet, and (iii) a gaseous headspace within the sachet containing a known volume fraction of the target-analyte.

7. The probe set of claim 6 wherein the second probe is remotely interrogatable.

8. The probe set of claim 6 wherein the first and second probes have the same optically-active material whereby a single optical detector having a single optical detection mechanism can interrogate both probes.

9. The probe set of claim 6 wherein (i) the optically active material on the first and second probes is sensitive to the partial pressure of oxygen, and (ii) the headspace of the sachet is filled with air.

10. The probe set of claim 8 wherein the optically active material is a photoluminescent material.

11. The probe set of claim 10 wherein the photoluminescent material is based upon a long-decay fluorescent or phosphorescent dye and is sensitive to the partial pressure of oxygen.

12. The probe set of claim 11 wherein the dye has a fluorescence or phosphorescence lifetime that changes in response to changes in the partial pressure of oxygen.

13. (canceled)

14. (canceled)

15. (canceled)

16. (canceled)

17. (canceled)

18. (canceled)

19. (canceled)

20. (canceled)

21. (canceled)

22. (canceled)

23. (canceled)

24. (canceled)

25. (canceled)

26. (canceled)

27. (canceled)

28. (canceled)

29. (canceled)

30. (canceled)

31. (canceled)

32. (canceled)

33. (canceled)

34. (canceled)

35. (canceled)

36. (canceled)

37. (canceled)

38. (canceled)

39. (canceled)

40. (canceled)

41. (canceled)

42. (canceled)

43. (canceled)

44. (canceled)

45. (canceled)

46. (canceled)

47. (canceled)

48. (canceled)

49. (canceled)

50. (canceled)

51. (canceled)

52. (canceled)

53. (canceled)

54. (canceled)

55. (canceled)

56. (canceled)

57. (canceled)

58. (canceled)

59. (canceled)

60. (canceled)

61. (canceled)

62. (canceled)

63. (canceled)

64. (canceled)

65. (canceled)
